(19) United States
(12) Patent Application Publication
(10) Pub. No.: US 2012/0204477 A1
(43) Pub. Date: Aug. 16, 2012

(54) ARTHROPOD CAPTURE SYSTEM AND METHOD

(75) Inventors: Joseph R. FAIRLEIGH, Boca Raton, FL (US); Jonathan A. GLOBERSON, Sunny Isles Beach, FL (US); Jeffrey Scott DiBARTOLO, Lighthouse Point, FL (US)

(73) Assignee: GREEN HOME SHIELD, LLLP, Deerfield Beach, FL (US)

(21) Appl. No.: 13/024,461

(22) Filed: Feb. 10, 2011

(51) Int. Cl. A01M 1/10

(52) U.S. Cl. 43/121

(57) ABSTRACT

A method and system for trapping arthropods including a base having a vertical axis, an outer wall coupled to the base and surrounding the axis, an inner wall coupled to the base and surrounding the axis, and a fluid source arranged to dispose the fluid between the outer wall and inner wall. The system may include an intermediate wall coupled to the base, the intermediate wall surrounding the axis and being disposed between the inner wall and the outer wall. The outer wall and the inner wall each have an interior and exterior surface, the interior surface of the inner wall and the exterior surface of the outer wall have a first texture, and the exterior surface of the inner wall and the interior surface of the outer wall have a second texture, the first texture being more coarse than the second texture.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for trapping arthropods and diagnosing their origin.

### BACKGROUND OF THE INVENTION

Arthropods are invertebrate animals including insects, arachnids and others creatures. Notably, the arthropod classification also includes a notorious household pest; bed bugs. This pest has been around for centuries and is one of the most widely recognized insects in the world. Even though bed bugs were thought to have all but disappeared in western countries due to the use of pesticides, they have reappeared in the United States. There are contributing factors to this growing bed bug epidemic such as increased resistance to pesticides and increased travel to and from bed bug infested countries. For example, arthropods have shown to have developed resistance to currently available insecticides. Regardless of the reason, a solution is needed to help stop and reverse the bed bug outbreak.

The use of pesticides to exterminate bed bugs is no longer commonly used due to the toxic nature of the chemicals. Specifically, most pesticides work by poisoning the bed bug, which in turn might end up poisoning a human. As such, industry professionals started using insecticides to control the bed bugs population. However, the effectiveness of insecticides is limited because they are not as toxic as pesticides. Even the use of stronger, more effective insecticides in a home or business is not desired due to the health effects of coming into contact with such chemicals. As such, buildings owners are wary of using any insecticides, let alone pesticides, to treat a bed bug infested site.

Moreover, using insecticides can have a disastrous effect on the treated site. For example, furniture or carpet being treated is highly susceptible to discoloring and even damage due to the chemicals in the insecticide. The fumes from insecticides are unappealing. Further, few people want their children playing in an area that may contain insecticide residue due to the fear that even the non-toxic insecticides may have hidden long term side effects. Accordingly, the use of insecticides is often a last resort due to their significant disadvantages.

In order to overcome this problem, non-insecticide approaches are being used. Such approaches vary from steam cleaning the arthropod inhabited area to wrapping the area in a specialized material. While these approaches may have some success, they are time consuming, costly and aesthetically unappealing. For instance, hiring professional steam cleaners is costly. Also, once steam cleaned, there is no way to know if the bed bugs will return to the area since they may also live in places that were not steam cleaned, such as hidden cracks in the walls. Also, individually wrapping every piece of furniture in a home with specially designed covers is costly and is likely to look unpleasant. As such, these approaches are unlikely to be used.

Notably, these approaches to eradicating bed bugs from a home also do not provide any valuable feedback other than that some bed bugs have been captured and/or killed. For example, even if a building owner manages to eradicate all bed bugs in a piece of furniture, the owner has no idea if the bed bugs lived only there or if they migrated there from another part of the building, i.e. the real source of arthropods is left undisturbed. As such, the bed bugs may simply continue to migrate back to re-infest the same piece of furniture or area over and over.

Moreover, none of these approaches take advantage of the bed bugs' own senses to lure them into a trap, thereby increasing the trap's effectiveness. A bed bug's necessity to feed on blood has led them to develop keen senses, allowing them to find a suitable host, e.g. mammals such as humans and house pets, to feed on. For example, bed bugs have been found to be attracted to carbon dioxide, circulating blood and host kairomones, e.g. dried human sweat. In some situations, bed bugs have been able to locate a host up to 1.5 meters away, likely based in part on their senses. Nevertheless, these approaches fail to utilize a bed bug's own senses against it to trap and/or kill it.

Consequently, there is a need in the art for an arthropod trapping device and method to efficiently and effectively capture arthropods, such as bed bugs, without the use of pesticides, insecticides and/or costly equipment. There is also a need in the art for an arthropod trapping device and method that provides the user with valuable feedback regarding the trapped arthropods without having to spray a chemical onto or around the infested area that might leave a residue.

### SUMMARY OF THE INVENTION

The present invention advantageously provides a device, system and method for trapping arthropods. The present invention efficiently and effectively captures arthropods, such as bed bugs, without the use of insecticides and/or costly equipment. The present invention also provides a user with visual feedback regarding the origin of the trapped arthropods.

In one aspect of the invention, the device for trapping arthropods includes a base having a vertical axis, an outer wall coupled to the base and surrounding the axis, and an inner wall coupled to the base and surrounding the axis. The device also includes an intermediate wall coupled to the base. The intermediate wall surrounds the axis and is disposed between the inner wall and the outer wall. Each wall has an interior and exterior surface. The interior surface of the inner wall and the exterior surface of the outer wall have a first texture, and the exterior surface of the inner wall and the interior surface of the outer wall have a second texture is that the first texture is more coarse than the second texture.

In another aspect of the invention, the system for trapping arthropods includes a base having a vertical axis, an outer wall coupled to the base and surrounding the axis, and an inner wall coupled to the base and surrounding the axis. The system also includes a fluid source arranged to dispose the fluid between the outer wall and inner wall.

In yet another aspect of the invention, the method for trapping arthropods and diagnosing arthropod origination includes positioning a trap. The trap includes a base having a vertical axis, an outer wall coupled to the base and surrounding the axis, and an inner wall coupled to the base and surrounding the axis. The trap also includes an intermediate wall coupled to the base. The intermediate wall surrounds the axis and is disposed between the inner wall and the outer wall.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary multi-wall arthropod trapping system constructed in accordance with the present invention;

FIG. 2 is a top view of an embodiment of the multi-wall arthropod trapping system constructed in accordance with the present invention;

FIG. 3 is a bottom view of an embodiment of the multi-wall arthropod trapping system constructed in accordance with the present invention;

FIG. 4 is a cross-sectional view taken through section A-A of FIG. 2 and through section A-A of FIG. 6.

FIG. 5 is a perspective view of an alternate embodiment of the multi-wall arthropod trapping system constructed in accordance with the present invention; and

FIG. 6 is a top view of the embodiment of the multi-wall arthropod trapping system of FIG. 5.

### DETAILED DESCRIPTION OF THE INVENTION

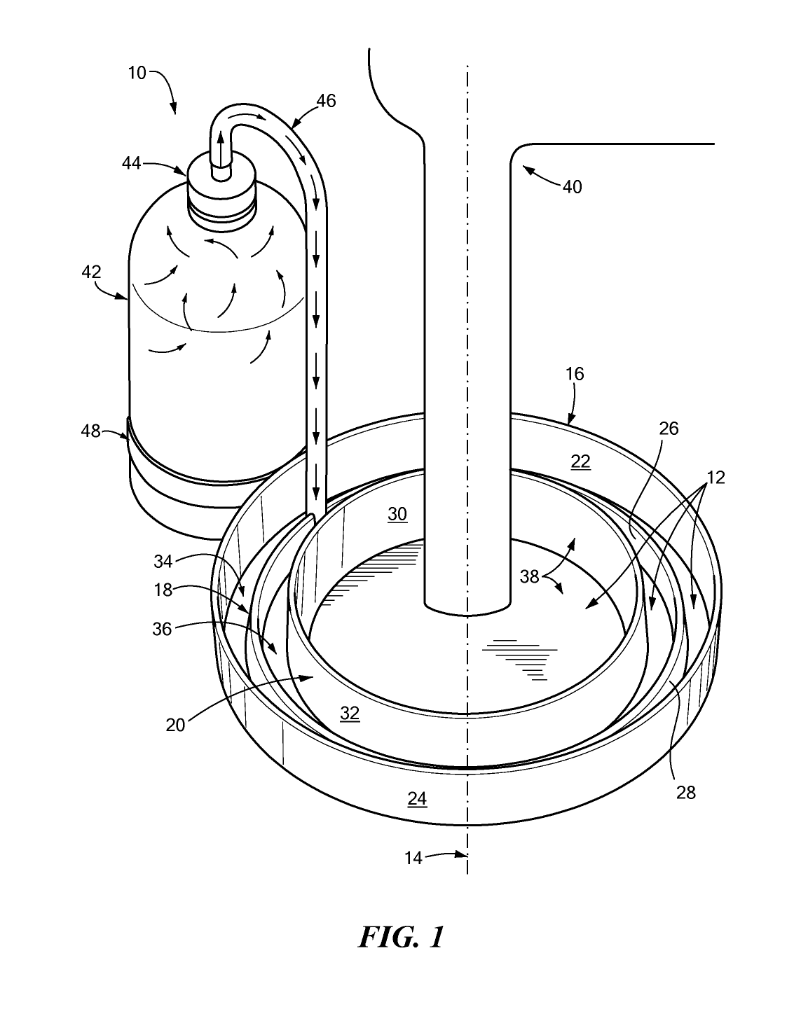

The present invention advantageously provides a multi-wall arthropod trapping device incorporating direct fluid injection that effectively traps arthropods and provides visual feedback regarding the source, e.g. nest or home, of arthropods. Referring now to the drawing figures, in which like reference designators refer to like elements, there is shown in FIG. 1 a system constructed in accordance with the principles of the present invention and designated generally as “10.” System 10 includes a base 12 having a vertical axis 14 and a plurality of walls 16, 18 and 20 coupled to the base 12. Each wall may concentrically surround the vertical axis 14. The outer wall 16 may include an interior surface 22 and an exterior surface 24. The intermediate wall 18 may include an interior surface 26 and an exterior surface 28. The inner wall 20 may include an interior surface 30 and an exterior surface 32.

Also, the system 10 may include a first channel 34 and a second channel 36 disposed between the outer wall 16 and the inner wall 20. Each channel serves to trap arthropods. A receptacle 38 may also be included and defined by the inner wall 20 and base 12. Further, the receptacle 38 may accept placement of an upstanding member 40 within. The system 10 may further include a container 42 for holding fluid and/or other materials and/or dispensing a fluid. As used herein the term “fluid” is used in the traditional sense and refers to a liquid, a gas or a combination thereof. The container 42 may include a removably affixed lid 44 allowing access to the interior of the container 42. System 10 may also include a tube 46 removably affixed to the container 42 that may provide a fluid path from the container 42 to the first channel 34 and/or the second channel 36. A clip 48 may also be included in system 10 to allow container 42 to be removably affixed to the base 12.

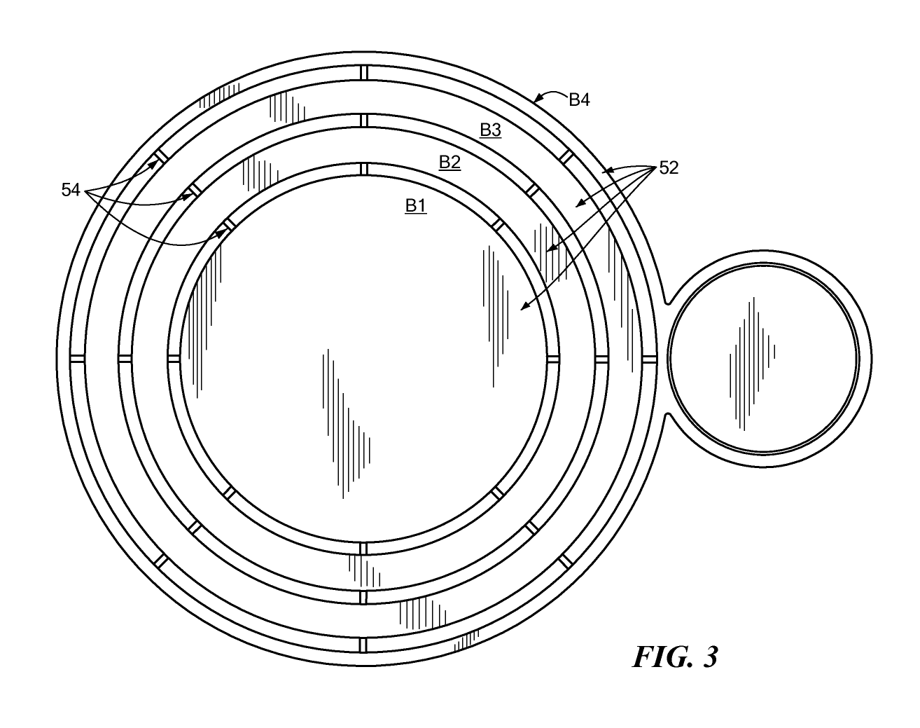

In particular, with reference to FIG. 1, the base 12 may include a platform, bottom support or a substantially horizontal surface that may be composed of a polymer, metal and the like. The base 12 may be formed by several sections coupled together as is discussed below with reference to FIG. 3. Alternatively, the base 12 may be formed as a single piece.

The vertical axis 14 is an imaginary axis utilized for reference and positioned substantially perpendicular to a planar surface of the base 12 as shown in FIG. 1. The vertical axis 14 may be positioned at substantially the center of the base or at any other position on the base.

The outer wall 16 has a height, width and thickness and may be coupled to the base 12, and surrounding the vertical axis 14. The outer wall 16 may be positioned proximate the perimeter of the base 12, so as to substantially conform to the shape of the base 12. For example, as shown in FIG. 1, the outer wall 16 substantially conforms to the circular shape of the base 12. While the circular shape is shown in FIG. 1, the base 12 and outer wall 16 may have different shapes. Also, the outer wall 16 may be composed of the same material used for the base 12 or may be composed of different material.

The interior surface 22 of the outer wall 16 is positioned substantially facing the vertical axis 14 and may have a smooth texture. In particular, a smooth surface, as used herein, describes a surface with a texture that prevents arthropods from climbing the surface, e.g. arthropods cannot hook their claws onto the surface. For example, the texture may be so fine that it may appear and feel substantially smooth. The exterior surface 24 of the outer wall 16 is positioned opposite to the interior surface 22 of the outer wall 16 and may include a surface with a coarse texture. Specifically, as used herein, a coarse texture describes a surface with a texture that allows arthropods to climb the surface, e.g. allows arthropods to hook their claws onto the surface. One of ordinary skill in the art will understand that a smooth and/or coarse surface may come from the properties of the material being used or may be created by the use of machining, coatings, and the like. The outer wall 16 may also include a tapered upper portion (not shown) so as to produce a narrow peak that may facilitate arthropods falling over to the other side of the outer wall 16, i.e. towards the first channel 34. The tapered upper portion of the outer wall 16 may be sloped, flat, multi-sided, inwardly sloped, symmetric, non-symmetric and the like.

Moreover, surface roughness (Ra) may also be used to reference the texture of a surface. In particular, surface roughness is the arithmetic average deviation of the surface valleys and peaks, expressed in microns that indicate a measure of the surface texture. While not specified herein, the interior surface 22 of the outer wall 16 may have a surface roughness rating capable of preventing arthropods from climbing the surface. While the exterior surface 24 of the outer wall 16 may have a surface roughness rating capable of allowing arthropods to climb the surface. All other surfaces may have a Ra rating based on their respective function in the system 10. By way of non-limiting example, the smooth textured services can have an Ra rating in the range of about 0.1 micrometers (μm) to about 3.0 μm, and the course surfaces can have an Ra rating of about 4.0 μm and up. Please note that each smooth surface and each course surface need not have the exact same respective Ra rating.

The intermediate wall 18 may be defined by a wall having a height, a width and a thickness, and may be coupled to the base 12 and surrounds the vertical axis 14. The height of the intermediate wall may be the same or different from the height of the outer wall. The intermediate wall 18 may be disposed in between the outer wall 16 and the inner wall 20. The intermediate wall 18 may be composed of the same material of the base 12 or a different material. The interior surface 26 of the intermediate wall 18 may be positioned substantially facing the vertical axis 14. The intermediate wall 18 may have a tapered upper portion (not shown). The tapered upper portion of the intermediate wall 18 may be sloped, flat, multi-sided, inwardly sloped, symmetric, non-symmetric and the like.

The inner wall 20 may be defined by a wall having a height, a width and a thickness, and may be coupled to the base 12 and surrounds the vertical axis 14. The height of the inner wall may be the same or different from the height of the intermediate wall and/or the outer wall. Specifically, the inner wall 20 may be positioned in between the intermediate wall 18 and the vertical axis 14. The inner wall 20 may be composed of a material that is the same or different from the material used for the base 12.

The interior surface 30 of the inner wall 20 may be positioned substantially facing the vertical axis 14. The interior surface 30 of the inner wall 20 may have a coarse texture that may allow arthropods to climb the interior surface 30 of the inner wall 20. The exterior surface 32 of the inner wall 20 may be positioned substantially opposite to the interior surface 30 of the inner wall 20 and may have a smooth texture that may prevent arthropods from climbing the exterior surface 32 of the inner wall 20. The inner wall 20 may also include a tapered upper portion (not shown) so as to produce a narrow peak that may facilitate arthropods falling over to the other side of the outer wall 16, i.e. towards the second channel 36. The tapered upper portion of the inner wall 20 may be sloped, flat, multi-sided, inwardly sloped, symmetric, non-symmetric and the like.

Still referring to FIG. 1, the first channel 34 may be defined by the area between the outer wall 16 and the intermediate wall 18. In particular, the first channel 34 may be defined by the interior surface 22 of the outer wall 16, exterior surface 28 of the intermediate wall 18 and the base 12, each serving as a different side of the first channel 34, with another side being open to the environment. The first channel 34 may function to trap arthropods that have arrived there within. In particular, the smooth texture of the surfaces 22 and 28 will prevent arthropods from climbing out of the first channel 34. Also, due to the smooth/coarse texture configuration of the walls in system 10, arthropods trapped in the first channel 34 have likely fallen in from climbing over the exterior surface 24 of the outer wall 16, as is discussed below.

The second channel 36 may be defined by the interior surface 26 of the intermediate wall 18, exterior surface 32 of the inner wall 20 and base 12, each serving as a different side of the second channel 36, with the side opposite the base 12 being open to the environment. The smooth texture of the surfaces 26 and 32 will prevent arthropods from climbing out of the second channel 36. Also, due to the smooth/coarse texture configuration of the walls in the system 10, arthropods trapped in the second channel 36 have likely arrived by climbing over the interior surface 30 of the inner wall 20 as discussed below.

The system 10 may also include a receptacle 38 defined by the inner wall 20 and the base 12. The receptacle 38 may function to receive placement of an upstanding member 40. For example, the upstanding member 40 may be a furniture leg such as a bed leg or sofa leg.

The container 42 has an aperture (not shown) to hold fluid and/or other materials and dispense fluid. The container 42 may be composed of plastic, glass, metal and/or any other material suitable for holding fluid and/or other materials and dispensing fluid. The lid 44 may also include a conduit extending from a portion of the lid 44. The lid 44 may be removably affixed to the container 42 to allow a person to place fluid and/or other materials inside the container 42. For example, the user may fill the container 42 with water and drop tablets of specific ingredients into the water to produce carbon dioxide.

The container 42 may also have a fluid regulator (not shown) to control the flow of fluid from the container 42 to the tube 46. For example, the fluid regulator may simply be the dimensions of the container 42 and/or tube 46 that may cause the fluid to slowly dispense from the container 42. Also, additional components may be used to control the fluid flow from the container 42 such as a lid 44 with an adjustable opening. Other types of fluid regulators may be used in accordance with the workings of the system 10.

Tube 46 has a distal end and a proximal end. The proximal end of the tube 46 may be removably affixed to the lid 44 and the distal end of the tube 46 may be disposed in between the outer wall 16 and the inner wall 20. In particular, the tube 46 functions as a fluid path, allowing fluid to travel from the container 42 to the first and/or second channels. For example, the tube 46 may serve as a path for carbon dioxide to travel, eventually being dispensed in the first and/or second channels.

The fluid may be selected based on its arthropod attracting properties. The fluid being used may be guided via the tube 46 to the first and/or second channels. Once dispensed in the channel, the fluid may diffuse onto the entire device and subsequently to the surrounding area. However, the concentration of fluid may remain strongest within the first and/or second channels, i.e. remain strongest at the source. As such, arthropods, e.g. bed bugs, may seek out the source of fluid likely believing the source to be a host to feed on.

Also, the fluid may be selected based on other properties. For example, using water soluble tablets that mix with the liquid to create carbon dioxide has many advantages. First, water soluble tablets may be used to produce carbon dioxide for a substantial period of time, e.g. approximately 4-5 days. Also, the mixture will indicate that no more carbon dioxide is being emitted because the water will turn substantially clear and no more bubbles will form when the container 42 is shaken. At this point, any leftover contents in the container 42 may be rinsed and poured down the sink without fear of harming the environment, i.e. any leftover contents in the container 42 are non-toxic and non-corrosive. Moreover, the tablets used to create the carbon dioxide are inexpensive, a feature that enables lower income families to run and re-run the system 10 as many times as needed.

Furthermore, carbon dioxide in the quantities released is non-threatening to consumers as it is commonly found in our environment, e.g. humans release carbon dioxide when breathing. Also, carbon dioxide does not leave any residue on furniture, thereby helping simplify clean up. Another advantage is that arthropods are highly attracted to carbon dioxide. The use of an attractant may encourage arthropods to leave their nesting place(s) such as inside a piece of furniture and/or inside a crack in the wall and travel to the trapping system 10. One of ordinary skill in the art will recognize that other types of fluids and mixtures of fluids and/or solids may be used to produce carbon dioxide.

Additionally, Diatomaceous Earth may be disposed, e.g. sprayed, scattered, sprinkled and the like, onto the trap to incapacitate any arthropods that venture into the trap. In particular, Diatomaceous Earth may be sprayed onto the entire trap or a portion of the trap. For example, Diatomaceous Earth may be sprayed only onto the first and second channels to incapacitate arthropods located in the first and second channels. Specifically, Diatomaceous Earth is a silica dioxide powder that may incapacitate arthropods mechanically, instead of chemically (e.g. pesticides). For example, the Diatomaceous Earth may act similar broken glass when an insect ingests it or crawls on top of it, thereby incapacitating the arthropod mechanically. Also, Diatomaceous Earth may make surfaces more difficult to climb when added to the trap, e.g. Diatomaceous Earth makes surfaces more slippery or less coarse. Different concentrations of Diatomaceous Earth may be disposed onto the trap depending on a number of factors such as user preference, availability and the like. For example, Diatomaceous Earth containing less than 3% silica dioxide may be used. As such, Diatomaceous Earth may be added to the arthropod trap to lessen the chance of an arthropod escaping.

The flexible clip 48 is coupled to the exterior surface 24 of the outer wall 16. The clip 48 may function to removably affix the container 42 to the outer wall 16. Also, a container receptacle (not shown) may be used instead of a clip 48. The container receptacle may be coupled to the exterior surface 24 of the outer wall 16 and may have a similar configuration to the receptacle 38. For example, a container receptacle may be defined by an upstanding wall coupled to a container receptacle base, in which the container receptacle base may be an extension of base 12. Therefore, container 42 may be partially disposed within the container receptacle so as to be removably affixed to the base 12.

The system 10 also provides visual feedback regarding the general location or origin from which arthropods traveled towards the system 10. This visual feedback is made possible through the use of the system 10 smooth/coarse surface wall configuration. Arthropods may travel toward the system 10 from two general directions: (1) from the substantially horizontal plane on which the system 10 rest, e.g. the floor; and (2) from the substantially vertical plane associated with the upstanding member 40. In particular, arthropods may travel from other parts of the building, likely crawling on a floor, e.g. substantially horizontal plane, to reach the system 10. Also, arthropods may climb down toward the floor from another part associated with the upstanding member 40, e.g. another leg touching the floor, subsequently reaching the system 10 by crawling on a floor. However, arthropods may also reach the system 10 via the upstanding member 40. For example, arthropods may travel down the upstanding member, e.g. from a bed leg, and directly into the receptacle 38. As such, there may be two general directions from which arthropods travel to get to the trap.

In particular, the arthropods traveling down the upstanding member 40 and directly into the receptacle 38 may climb over the interior surface 30 of the inner wall 20 toward the source of fluid. Once over the wall, the arthropods may fall into the second channel 36 where they will be unable to climb out due to the smooth surfaces 26 and 32. However, the arthropods traveling from the other general direction may climb over the exterior surface 24 of the outer wall 16 towards the source of fluid. Once over the outer wall 16, the arthropod may fall into the first channel 34 where it will be unable to climb out due to the smooth surfaces 22 and 28. As such, the consumer or user of the system 10 will be able to identify the general direction(s) or origins from which arthropods are traveling towards the system 10 based in which channel the arthropods are located. For example, the user may determine that an arthropod has approached the trap from an area exterior to the outer wall because the arthropod is trapped in the first channel. Also, the user may determine that an arthropod has approached the trap from the upstanding member 40 because the arthropod is trapped in the second channel. In other words, the visual feedback provided by the system 10 may alert a user that arthropods are coming from places in the building other than the particular piece of furniture whose leg is placed inside the receptacle 38.

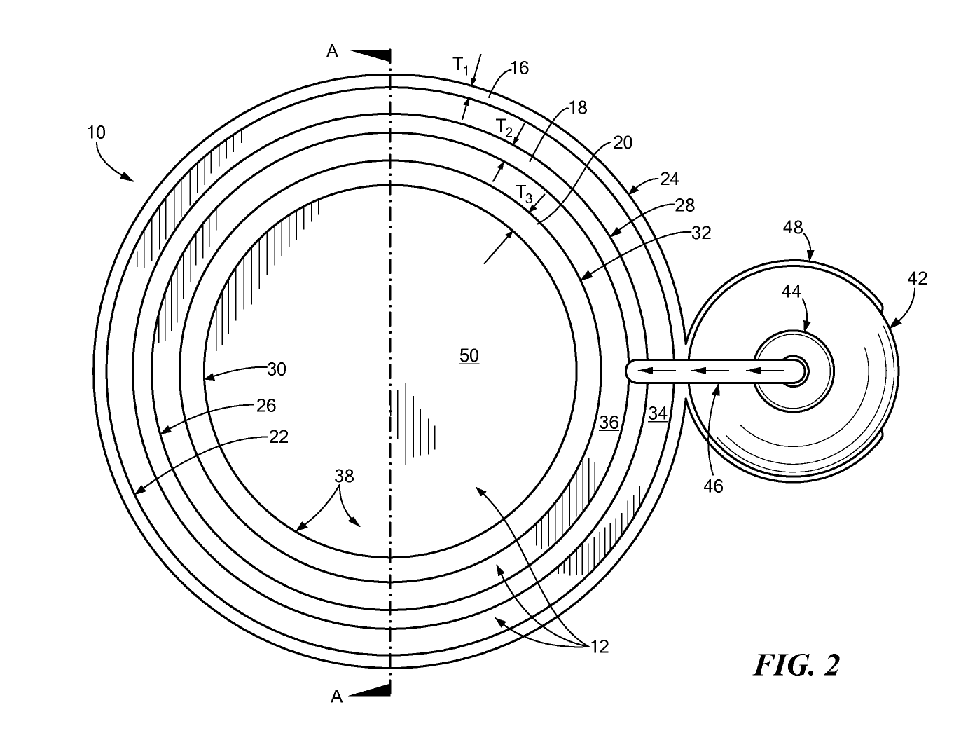

FIG. 2 illustrates a top view of the system 10. The thicknesses of the walls surrounding the vertical axis 14 are indicated by T1, T2 and T3. In particular, the outer wall 16 thickness T1 may be substantially constant throughout as shown in FIG. 2. Similarly, the intermediate wall 18 thickness T2 may be substantially constant throughout. The inner wall 20 thickness T3 may also be substantially constant throughout. Alternatively, the thicknesses of the walls may be varied, e.g. tapered. Also, the thickness T1, T2 and T3 may be varied in various combination, e.g. all the thickness are substantially equal, T1 is thicker than T3, T2 is thicker than T3, and the like.

The receptacle 38 for receiving an upstanding member 40 is illustrated in FIG. 2. The upstanding member 40 may rest on the portion of the base 12 that is disposed within the inner wall 20, e.g. the receptacle surface 50 of base 12. Also, FIG. 2 illustrates the clip 48 that may be used to removably affix the container 42 to the outer wall 16. In particular, the clip 48 may be designed to conform to the shape of the container 42, e.g. a circular clip. The clip 48 may also be designed to wrap around a part or all of the container 42.

While FIG. 2 shows the receptacle surface 50 of base 12 being solid, alternatively, an opening may be formed in receptacle surface 50 (a portion of base 12), e.g. forms a donut-like shape with a hole in the center. This alternative configuration may allow the system 10 be re-positioned without having to lift the upstanding member 40 off receptacle surface 50 because the upstanding member will rest on the same surface as the system 10, thereby making the system 10 easier to configure. Furthermore, the system 10 may include one or more pieces that are detachably affixed to one another to allow the base 12 and walls (16, 18, 20) to be detachably affixed around the upstanding member 40 without having to lift or reconfigure the upstanding member 40. For example, the base 12 may be divided into two pieces that may be detachably affixed to one another, via a locking mechanism known in the art, to allow a user to position the system 10 around upstanding member 40 by locking the ends of the pieces together.

FIG. 3 illustrates a bottom view of system 10. In particular, the bottom surface 52 is shown. The bottom surface 52 may comprise several sections denoted by B1, B2, B3 and B4. Added support to each section may be provided by support members 54 that attach to adjacent bases. For example, the support members 54 may be located within the hollow spaces between B1 and B2 and may connect the base sections at various locations, thereby adding structural support to the system 10. Moreover, the hollow spaces and base sections (B1-B4) may be created through injection molding, which keeps material cost down due to the use of less material. Also, the bottom surface 52 may comprise just one section that covers the same area as B1, B2, B3 and B4.

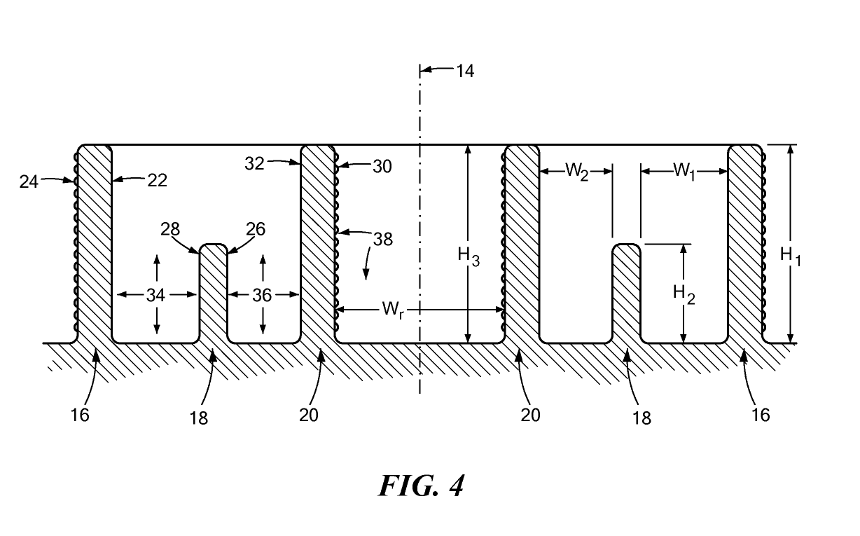

FIG. 4 is a view taken through section A-A of FIG. 2. Starting with the outside of the system 10, the outer wall 16 may be substantially parallel to the vertical axis 14 and may have a height H1. The exterior surface 24 of the outer wall 16 may have a coarse texture. For example, the coarse texture may include bumps as shown in FIG. 4, and may function to allow arthropods to climb this surface. Other textures may also be suitable for arthropods to climb, such as textures having non-uniform indentations, divots, differently shaped bumps and the like. The interior surface 22 of the outer wall 16 may have a smooth texture as compared with the course texture to prevent arthropods from climbing the interior surface 22.

Also, the intermediate wall 18, as shown in FIG. 4, may have a height H2 and may be substantially parallel to the vertical axis 14. The exterior surface 28 and interior surface 26 of the intermediate wall 18 may have a smooth texture that may function to prevent arthropods from climbing these surfaces, thereby helping trap the arthropods. In particular, an arthropod may be trapped in the first channel 34 due to the smooth surface 22 of the interior of the outer wall 16 and the exterior surface 28 of the intermediate wall 20.

Still referring to FIG. 4, the inner wall 20 may have a height H3 and may be substantially parallel to the vertical axis 14. The exterior surface 32 of the inner wall 20 may have a smooth texture that may function to prevent arthropods from climbing the surface. In particular, the arthropods may be trapped in the second channel 36 due to the smooth exterior surface 32 of the inner wall 20 and the smooth interior surface 26 of the intermediate wall 18. Moreover, the interior surface 30 of the inner wall 20 may have a coarse texture. For example, the coarse texture may include bumps as shown in FIG. 4, and may function to allow arthropods to climb this surface. Other textures may also be suitable for arthropods to climb, such as textures having non-uniform indentations, divots, differently shaped bumps and the like.

The height of the walls shown in FIG. 4, H1, H2 and H3, may also be varied depending on the needs of the consumer. For example, the intermediate wall 18 height H2 may be increased so as to be able to trap larger arthropods inside the first and/or second channels. Also, the outer wall height H1 and the inner wall 20 height H3 may be decreased in order to reduce the overall profile of the trap, e.g. making the trap less visible.

Still referring to FIG. 4, the widths of the receptacle 38 (Wr), first channel 34 (W1) and second channel 36 (W2) may also be varied depending on the needs of the consumer. For example, the widths of the first and second channels may be increased in order to be able to trap larger arthropods. Also, the receptacle width may be increased in order to accommodate larger upstanding elements such as a larger piece of furniture. Moreover, the widths shown in FIG. 4, W1, W2 and Wr, may be reduced in order to reduce the overall profile of the trap, e.g. making the trap less visible. While FIG. 4 shows the widths W1 and W2 being substantially equal, the widths may be varied relative to each other. Additionally, for clarity, FIG. 4 shows the walls 16, 18 and 20 as being solid; however, the walls 16, 18 and 20 may alternatively be hollow to reduce the weight of the system 10, e.g. leaving only a shell of the system 10.

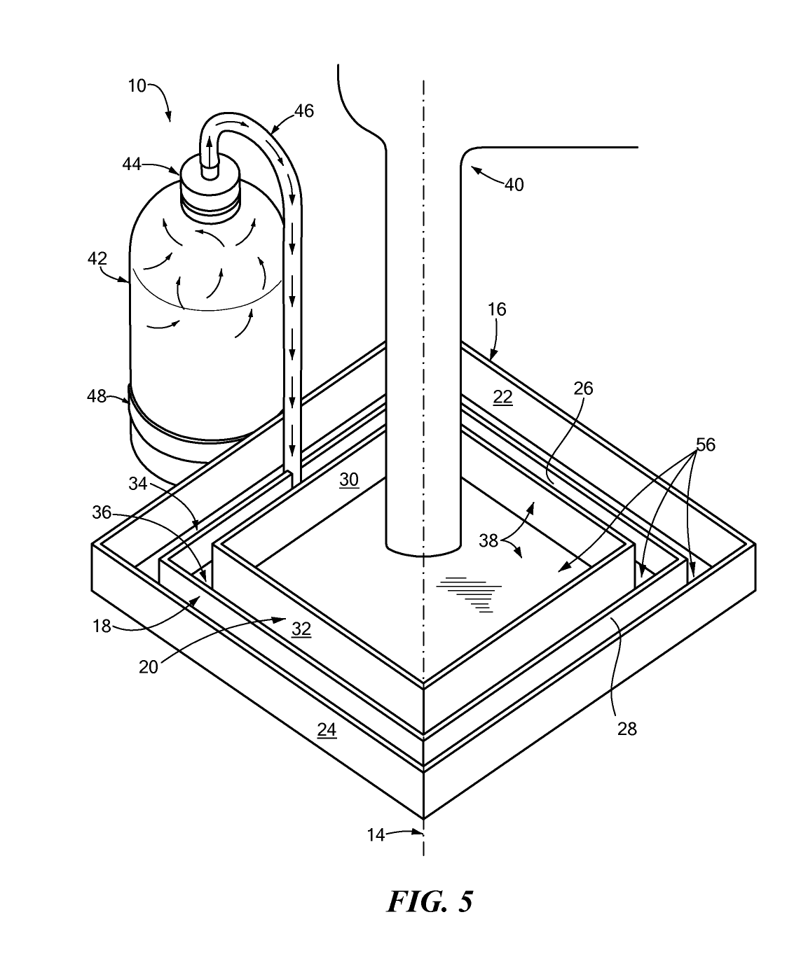

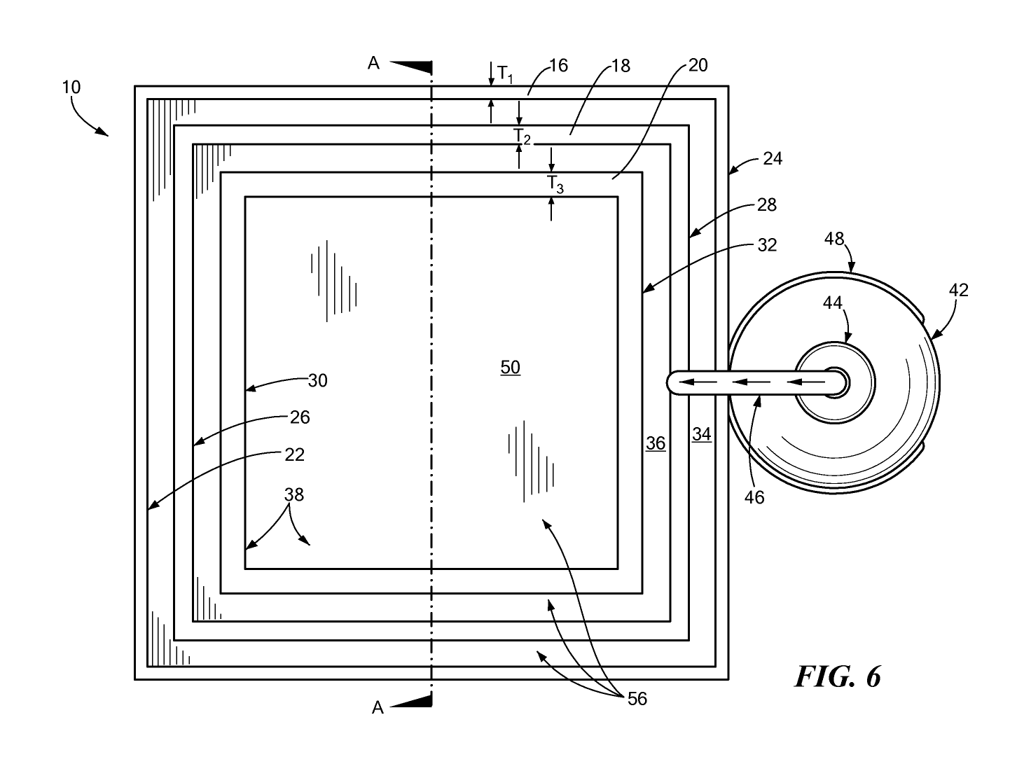

FIGS. 5 and 6 illustrate an alternate embodiment of system 10 The functions and possible modifications of each element referenced and discussed with respect to FIG. 1 and FIG. 2 are equally applicable to FIG. 5 and FIG. 6. Referring to FIG. 5, the base 56 and the walls 16, 18 and 20 may each have a substantially quadrangular shape. The quadrangular shape of the walls 16, 18 and 20 may serve to increase the cross-sectional area of the first channel 34 and the second channel 36 that may allow for trapping of larger arthropods. Also, the increased cross-sectional area of base 56 may serve to increase the overall stability of system 10, e.g. may help prevent system 10 from tipping over when placed on an uneven surface. Moreover, although FIGS. 5 and 6 show a substantially square shaped base, the shapes of the base 56 and walls 16, 18 and 20 may be reconfigured into other variations that may include geometric shapes, non-geometric shapes or a combination thereof. For example, an upstanding member 40 having an unusual shape may require a different variation of system 10 than shown in FIG. 5.

With reference to FIG. 6, the quadrangular shape of inner wall 20 may increase the cross-sectional area of the receptacle surface 50 to allow placement of a larger upstanding member 40. Furthermore, due to the geometries of system 10 illustrated in FIG. 2 and FIG. 6, the cross-sectional view taken through section A-A of FIG. 6 is the substantially the same as the cross-sectional view taken through section A-A of FIG. 2 discussed above with reference to FIG. 4. As such, the discussion of FIG. 4 is equally applicable to the variation of system 10 shown in FIG. 6. Also, other variations of system 10 having other shapes than those shown in FIG. 2 and FIG. 6 may have different cross-sectional areas than illustrated in FIG. 4; however, the elements referenced in FIG. 4 will remain substantially the same, e.g. other variations may also have an outer wall 16, intermediate wall 18 and inner wall 20.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for trapping arthropods, the device comprising:
a base having a vertical axis;
an outer wall coupled to the base and surrounding the axis;
an inner wall coupled to the base and surrounding the axis;
an intermediate wall coupled to the base, the intermediate wall surrounding the axis and being disposed between the inner wall and the outer wall; and
each wall having an interior and exterior surface, the interior surface of the inner wall and the exterior surface of the outer wall having a first texture, and the exterior surface of the inner wall and the interior surface of the outer wall having a second texture, the first texture being more coarse than the second texture.

2. The device of claim 1, wherein the interior surface and exterior surface of the intermediate wall have the second texture.

3. The device of claim 2, further comprising:
a first channel defined by the inner wall and the intermediate wall, the first channel arranged to retain the fluid; and
a second channel defined by the outer wall and the intermediate wall, the second channel arranged to retain the fluid.

4. The device of claim 1, wherein the base has a quadrangular shape.

5. The device of claim 1, wherein the outer wall and inner wall each have a height greater than a height of the intermediate wall.

6. The device of claim 1, wherein the base further includes an opening disposed within a circumference of the inner wall.

7. A system for trapping arthropods, the system comprising:
a base having:
a vertical axis;
an outer wall coupled to the base and surrounding the axis;
an inner wall coupled to the base and surrounding the axis; and
a fluid source arranged to dispose the fluid between the outer wall and inner wall.

8. The system of claim 7, further comprising an intermediate wall coupled to the base, the intermediate wall surrounding the vertical axis and being disposed between the inner wall and the outer wall.

9. The system of claim 8, the outer wall and the inner wall each having an interior and exterior surface, the interior surface of the inner wall and the exterior surface of the outer wall each having a first texture, and the exterior surface of the inner wall and the interior surface of the outer wall each having a second texture, the first texture being more coarse than the second texture.

10. The system of claim 9, wherein the interior surface and exterior surface of the intermediate wall have the second texture.

11. The system of claim 10, wherein the outer wall and the inner wall each have a tapered upper portion.

12. The system of claim 11, wherein the outer wall and the inner wall each have a height greater than a height of the intermediate wall.

13. The system of claim 7, wherein the source of fluid further comprises:
a container; and
a fluid conduit having a distal end and a proximal end opposite the distal end, the proximal end of the fluid conduit coupled to the container, and the distal end of the fluid conduit disposed between the outer wall and the inner wall.

14. The system of claim 12, wherein at least one of a portion of the base, a portion of the outer wall and a portion of the inner wall is coated with diatomaceous earth.

15. A method for trapping arthropods and diagnosing arthropod origination, comprising:
positioning a trap, the trap having:
a base having a vertical axis;
an outer wall coupled to the base and surrounding the axis;
an inner wall coupled to the base and surrounding the axis; and
an intermediate wall coupled to the base, the intermediate wall surrounding the axis and being disposed between the inner wall and the outer wall.

16. The method of claim 15, further comprising supplying a fluid between the outer wall and inner wall.

17. The method of claim 16, wherein positioning the trap includes placing an object within a circumference formed by the inner wall.

18. The method of claim 17, wherein the inner wall and the intermediate wall define a first channel and the intermediate wall and the outer wall define a second channel, and wherein supplying a fluid further comprises supplying the fluid into the first channel and the second channel.

19. The method of claim 17, further comprising determining that an arthropod has approached the trap from an area exterior to the outer wall when the arthropod is trapped in the first channel; and
determining that the arthropod has approached the trap from the object when the arthropod is trapped in the second channel.

20. The method of claim 18, wherein the fluid includes carbon dioxide.
